(19) United States
(12) Patent Application Publication
(10) Pub. No.: US 2006/0197853 A1
(43) Pub. Date: Sep. 7, 2006

(54) Solid-state image pickup apparatus for correcting a seam between divided images and a method therefor

(75) Inventor: Takeshi Miyashita, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/366,480

(22) Filed: Mar. 3, 2006

(30) Foreign Application Priority Data
Mar. 7, 2005 (JP) 2005-62636
Feb. 3, 2006 (JP) 2006-27091

(51) Int. Cl. H04N 5/217

(52) U.S. Cl. 348/241

(57) ABSTRACT

A solid-state image pickup apparatus includes a signal processor for detecting, out of digital image signals representative of respective divided images, adjoining pixel data positioned at both sides of a seam between the divided images. A system controller includes a correction value calculator for calculating, based on the adjoining pixel data, correction values for correcting the seam between the divided images, and writing the correction values in a recorder. A seam corrector, included in a signal processor, corrects the digital image signals with the correction values read out from the recorder, thereby correcting the seam.

### BACKGROUND OF THE INVENTION

1. Field of the Invention

The present invention relates to a solid-state image pickup apparatus, and more particularly to a solid-state image pickup apparatus of the type capturing an image of a subject to produce a plurality of divided images to combine them into a single picture representative of the subject. The invention also relates to a method of capturing an image of a subject to produce a plurality of divided images to combine them into a single picture representative of the subject.

2. Description of the Background Art

A conventional type of solid-state image pickup apparatus is configured to read out imagewise signal charges from a photosensitive array, or imaging surface, formed by photosensitive cells at high speed through a plurality of horizontal transfer paths and a corresponding plurality of output circuits. Each of the output circuits outputs image data representative of a particular image, each of which forms, together with the other, a complete picture corresponding to the imaging surface.

Another type of conventional solid-state image pickup apparatus has its imaging surface physically divided into a plurality of regions. In this type of apparatus, signal charges are transferred from each region of the imaging surface to a particular horizontal transfer path so that image data are output in the form of corresponding plurality of data streams.

The problem with the solid-state image pickup apparatuses of the types described above is that the reference level of image data is different between the divided regions of the imaging surface and causes a boundary seam between the divided regions to be conspicuously displayed in a frame of image. In order to solve this problem, U.S. patent application publication No. US 2004/0090538 A1, for example, discloses correcting means for correcting the seam in an image between the divided regions of the imaging surface.

The correcting means taught in the above U.S. patent application determine beforehand correction values for correcting a seam. This, however, brings about another problem that various correction values, matching with various image pickup conditions including temperature and of lenses or optics, must be determined beforehand. Further, it is difficult for the correcting means to cope with all possible pickup conditions because the storage capacity of a memory is limited.

### SUMMARY OF THE INVENTION

It is an object of the present invention to provide a solid-state image pickup apparatus capable of easily obtaining, even when temperature or optical conditions vary, correction values for correcting a seam in an image between the divided regions of an imaging surface without resorting to any particular device.

A solid-state image pickup apparatus of the present invention is selectively operable of producing, at a preliminary pickup stage, an image by picking up a subject field or of obtaining, at an actual pickup stage, an exposure condition and a focus condition. The solid-state image pickup apparatus includes an image sensor including an imaging surface made up of a plurality of divided regions for producing a plurality of analog electric signal streams representative of a plurality of divided images on the basis of the divided regions. An analog signal processor executes analog signal processing on the plurality of analog electric signal streams and converts the resulting processed analog electric signals to a corresponding plurality of digital image signals. A digital signal processor executes digital signal processing on each of the plurality of digital image signals to thereby produce a single frame of image. The digital signal processor includes a detector for detecting out of the plurality of digital image signals a plurality of level decision data for determining level differences between the plurality of divided images. A correction value calculator calculates, at the preliminary pickup stage, correction values for correcting the level differences between the divided images in accordance with the plurality of level decision data. A corrector corrects, at the actual pickup stage, the plurality of divided images with the correction values calculated by the correction value calculator.

Also, an image input apparatus of the present invention inputs a plurality of divided image signals representative of a corresponding plurality of divided images. The image input apparatus includes a signal processor for processing the plurality of divided image signals to thereby produce a combined single image. A detector, included in the signal processor, detects a plurality of level decision data, which are used to determine level differences between the plurality of divided images, out of the plurality of divided image signals. A correction value calculator calculates correction values for correcting the level differences between the divided images in accordance with the plurality of level decision data. A corrector corrects the plurality of divided images.

An image correcting method practicable with the solid-state image pickup apparatus or the image input apparatus is also disclosed.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a preferred embodiment of the solid-state image pickup apparatus in accordance with the present invention;

FIG. 2 is a schematic block diagram conceptually showing an image pickup section included in the illustrative embodiment shown in FIG. 1;

FIG. 3 is a schematic block diagram partially showing an imaging surface also included in the illustrative embodiment;

FIG. 4 is a graph plotting curves of estimated contrast values with respect to focus positions unique to the illustrative embodiment;

FIG. 5 is a flowchart useful for understanding a specific operation of the illustrative embodiment;

FIG. 6 schematically shows another specific configuration of the image pickup section of the illustrative embodiment;

FIG. 7 also schematically shows still another specific configuration of the image pickup section of the illustrative embodiment;

FIG. 8 also schematically shows a further specific configuration of the image pickup section of the illustrative embodiment;

FIG. 9 is a block diagram schematically showing a further specific configuration of the image pickup section of the illustrative embodiment;

FIG. 10 schematically shows a modification of the image pickup section shown in FIG. 9; and

FIG. 11 is a graph plotting a curve of correction values with respect to positions on the imaging surface of the image pickup apparatus shown in FIG. 10.

### DESCRIPTION OF THE PREFERRED EMBODIMENTS

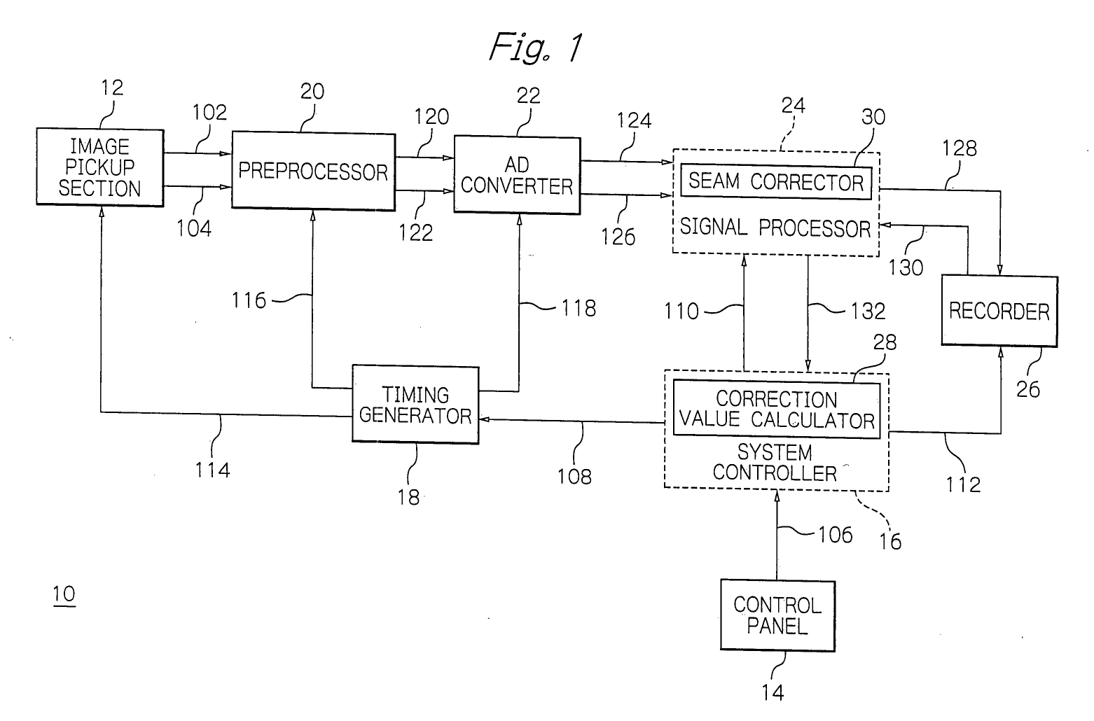

Referring to FIG. 1 of the accompanying drawings, a solid-state image pickup apparatus embodying the present invention, generally 10, includes an image pickup section 12 for picking up a desired scene to produce image data representative of the scene in the form of divided images. Briefly, the image pickup apparatus 10 includes a system controller 16 and a timing generator 18 operative in response to a control panel 14, when operated, to control a preprocessor 20, an analog-to-digital (AD) converter 22 and a signal processor 24 to process the signals of the divided images so that a correction value calculator 28, included in the system controller 16, calculates correction values for correcting level differences at a seam or boundary between the divided images and writes the correction values in a recorder 26 and a seam corrector 30, included in the signal processor 24, reads out the correction values from the recorder 26 to correct the seam with the correction values thus read out.

In FIG. 1, structural parts and elements not directly relevant to the understanding of the present invention are not shown, and detailed description thereof will not be made in order to avoid redundancy.

The image pickup apparatus 10 is selectively operable in an automatic focus (AF) mode for automatically focusing the optical image of a desired subject on the image pickup section 12 or a manual focus (MF) mode for allowing the operator to manually focus the former on the latter.

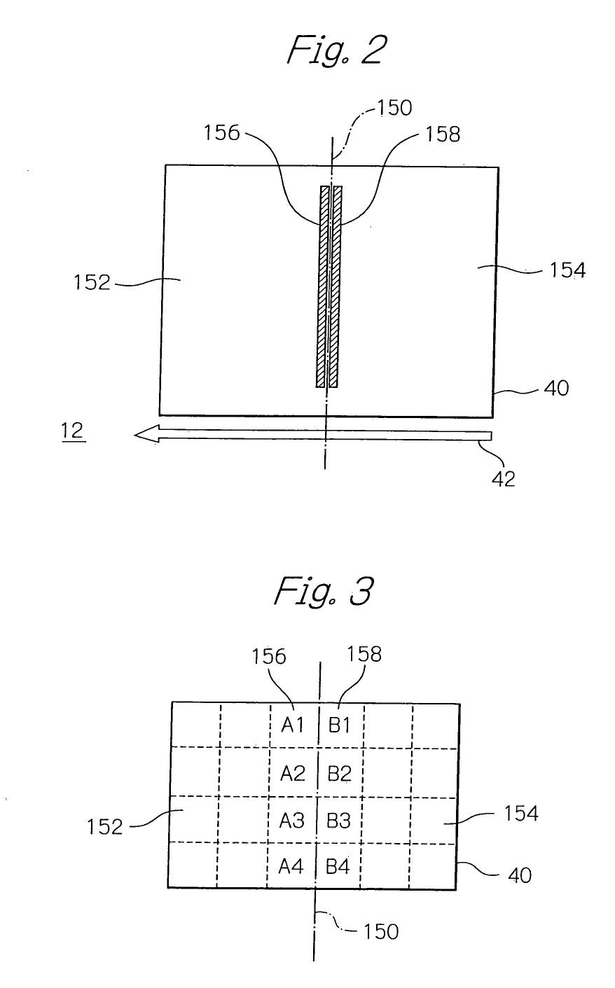

FIG. 2 shows a specific configuration of the image pickup section 12. As shown, the image pickup section 12 includes an imaging surface, or photosensitive array, 40 forming a single frame of image and a horizontal transfer path 42 arranged below of the imaging surface 40 in the figure. The imaging surface 40 includes a plurality of photosensitive cells or devices, each corresponding to a particular pixel, and a plurality of vertical transfer paths, which are not specifically shown in the figure. The image pickup section 12 may be implemented by a charge-coupled device (CCD), a MOS (Metal Oxide Semiconductor) or similar type of conventional image sensor.

In the illustrative embodiment, the imaging surface 40 is divided into a plurality of regions, which generate a corresponding plurality of divided image data. In the illustrative embodiment, let boundaries between the plurality of divided regions, e.g. a boundary between two divided regions, be referred to as a seam. As shown in FIG. 2, the imaging surface 40 specifically includes a couple of regions 152 and 154 adjoining each other arranged at opposite sides of a seam 150, i.e. left and right of the seam 150, by way of example. Among the pixels included in the regions 152 and 154, those adjoining the seam 150 will hereinafter be referred to as adjoining pixels 156 and 158, respectively. The regions 152 and 154 may be physically divided from each other, if desired.

Further, the image pickup section 12 serves as photo-electrically converting the optical image of a field focused on the imaging surface 40 to a corresponding analog electric image signal under the control of a timing signal 114, see FIG. 1, output from the timing generator 18. More specifically, as shown in FIG. 1, in the illustrative embodiment, the image pickup section 12 converts part of the optical image focused on the one region 152 and the other part of the same focused on the other region 154 to analog electric signals 102 and 104, respectively. It is to be noted that signals are designated by reference numerals attached to connections on which they appear.

Referring again to FIG. 1, the control panel 14 is manipulatable device operated by the operator for inputting desired commands. More specifically, the control panel 14 sends an operation signal 106 to the system controller 16 in response to the operator's operation, e.g. the stroke of a shutter release button, not shown, depressed by the operator. In the illustrative embodiment, the shutter release button may be of the type having its initial or non-depressed position, half-stroke position for commanding preliminary image pickup and full-stroke position for commanding actual image pickup.

The system controller 16 controls the operation of the entire image pickup apparatus 10 in response to the operation signal 106 received from the control panel 14. For example, in the illustrative embodiment, the system controller 16 controls the timing generator 18 and signal processor 24 with control signals 108 and 110, respectively. Also, the system controller 16 is responsive to the operation signal 106 for determining whether or not the shutter release button is depressed to its half-stroke or full-stroke position so as to produce the control signals 108 and 110 to indicate preliminary pickup if the shutter release button is in its half-stroke position or actual pickup if it is in its full-stroke position.

Further with the illustrative embodiment, when the shutter release button is in its half-stroke position indicative of preliminary pickup, the system controller 16 determines whether or not the focus control mode is the AF mode and then causes the control signal 108 applied to the timing generator 18 to indicate AF control, automatic exposure (AE) control and so forth in accordance with result of the above decision. Subsequently, the system controller 16 receives from the signal processor 24 an adjustment signal 132 including an estimated luminance value and an estimated contrast value and then determines an exposure and a focus condition for actual pickup in response to the adjustment signal 132.

For example, when the shutter release button is depressed to its half-stroke position, the system controller 16 causes, if the AF mode is selected, the control signal 108 to indicate AF and AE control, or causes, if the MF mode is selected, the control signal 108 to indicate only AE control while indicating MF control at a focus position manually selected by the operator.

Furthermore, when the shutter release button is held in its half-stroke position, the system controller 16 receives level decision data conveyed on an adjustment signal 132 for determining level differences between divided images from the signal processor 24, as data to be used for the calculation of correction values 112 at the seam or boundary. For example, data based on the adjoining pixels, which belong to the divided region in respective divided images, maybe input from the signal processor 24 to the system controller 16 as adjoining pixel data. At this instant, the correction value calculator 28, included in the system controller 16, calculates correction values 112 by using the adjoining pixel data and writes the correction values in the recorder 26. The adjoining pixel data input to the system controller 16 may preferably be adapted to receive adjoining pixel data based on divided images picked up at a defocus position, i.e. a position where a desired subject is inadequately focused.

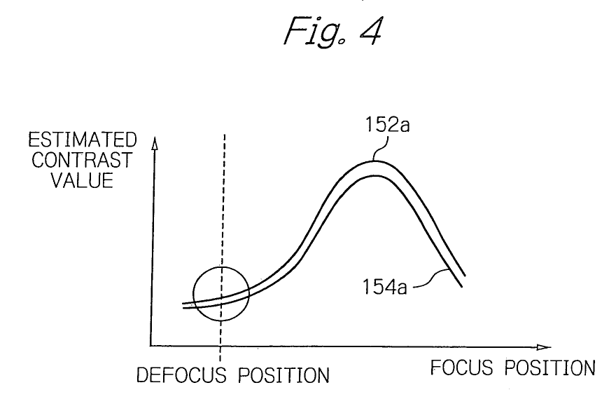

When the system controller 16 commands AF control, estimated contrast values at a focus position are produced. At this instant, assuming that estimated contrast values 152a and 154a shown in FIG. 4 are produced from the regions 152 and 154, respectively, of the imaging surface 40, then it is preferable to select a focus position where the estimated contrast values 152a and 154a vary little as a defocus position and produce adjoining image data picked up around that position.

For example, when the shutter release button is depressed to its half-stroke position while the AF mode is selected, the system controller 16 receives adjoining pixel data based on divided images, which are picked up at the defocus position during automatic focusing control. On the other hand, if the MF mode is selected when the shutter release button is in its half-stroke position, then the system controller 16 outputs the control signal 108 indicative of MF and AE control, and thereafter a control signal 108 indicative of pickup at a defocus position shifted from a focus position manually selected by the operator and then receives adjoining pixel data based on the resulting divided images.

The timing generator 18 functions as generating a timing signal 114, including a vertical and a horizontal synchronous signal, an electronic shutter pulse and so forth, in response to the control signal 108 input from the system controller 16 and delivers the timing control signal 114 to the image pickup section 12. In addition, the timing generator 18 generates a timing control signal 116 including sampling pulses for a correlated double sampling (CDS) circuit, not shown, and feeds the timing control signal 116 to the preprocessor 20. Further, the timing generator 18 feeds a timing control signal 118 including a conversion clock to the AD converter 22.

The preprocessor 20 includes various circuits, e.g. the CDS circuit mentioned above and a gain-controlled amplifier (GCA). The CDS circuit, gain-controlled amplifier and so forth, controlled by the timing control signal 116, execute analog processing on the analog electric signals 102 and 104 for thereby outputting the resulting analog image signals 120 and 122, respectively.

The AD converter 22 is adapted to be responsive to the timing control signal 118 to quantize the signal levels of the analog image signals 120 and 122 by use of a preselected quantizing level to output corresponding digital image signals 124 and 126, respectively.

The signal processor 24 is adapted to be controlled by the control signal 110 fed from the system controller 16 to receive, when the control signal 110 indicates the preliminary image pickup, the digital image signals 124 and 126 provided to produce the previously mentioned adjustment signal 132, including estimated luminance and contrast values, by arithmetic operations and deliver the adjustment signal 132 to the system controller 16. On the other hand, when the control signal 110 is indicative of actual pickup, the signal processor 24 executes white balance control, gamma correction, image combination, synchronization and other digital signal processing on the digital image signals 124 and 126, writing the resulting digital image signal 128 in the recorder 26.

Further, when the control signal 110 from the system controller 16 is indicative of preliminary pickup, the signal processor 24 detects level decision data for determining level differences between the divided image regions out of the digital image signals 124 and 126. For example, the signal processor 24 detects first adjoining pixel data based on the adjoining pixels 156, which belong to the image region 152, out of the digital image signal 124 and detects second adjoining pixel data based on the adjoining pixels 158, which belong to the image region 154, out of the digital image signal 126. The first and second adjoining pixel data thus detected are conveyed to the system controller 16 by the adjustment signal 132. In the illustrative embodiment, the signal processor 24 may preferably be adapted to generate the adjoining pixel data on the basis of the digital image signals 124 and 126 derived from data of an image picked up at the defocus position.

When the control signal 110 from the system controller 16 indicates actual pickup, the signal processor 24 reads out the seam correction values 130 stored in the recorder 26 and causes its seam corrector 30 to use the seam correction values to correct the seam between the divided images represented by the digital image signals 124 and 126.

The recorder 26 includes a data storing medium, not shown, for storing the digital image signal 128 fed from the signal processor 24. The data storing medium may be implemented by, e.g. a memory card loaded with a semiconductor memory device or a package loaded with a magneto-optical disk or similar recordable disk, which may be removably mounted to the image pickup apparatus 10.

Particularly, in the illustrative embodiment, the recorder 26 stores the seam correction values 112 input from the correction value calculator 28 of the system controller 16, and also feeds synchronizing signal values 130 stored therein to the seam corrector 30 included in the signal processor 24.

The correction value calculator 28 is adapted to calculate the seam correction values 112 in accordance with the adjoining pixel data conveyed from the signal processor 24 by the adjustment signal 132 and write them in the recorder 26. Alternatively, the correction value calculator 28 may be configured, if desired, to calculate correction values for correcting the offset of data of preselected adjoining pixels based on data of other adjoining pixels.

In the illustrative embodiment, the correction value calculator 28 uses the first and second adjoining pixel data derived from the adjoining pixels 156 and 158, respectively, included in the imaging surface 40 to calculate the seam correction values 112. For example, as shown in FIG. 3, assume that pixels A1, A2, A3 and A4 and pixels B1, B2, B3 and B4 are positioned as adjoining pixels 156 and 158, respectively, and that the data derived from the pixels A1 and B1 are A and B, respectively. Then, the correction value calculator 28 calculates a correction value for correcting the data B in accordance with the data A with a formula (A−B)/B+1. In this manner, the correction value calculator 28 is capable of calculating the offset of the adjoining image 158 relative to the adjoining image 156 in the form of correction value pixel by pixel.

In the case where R (red), G (green) and B (blue) or similar color filter segments are arranged at the adjoining pixels from which the adjoining pixel data should be produced, the correction value calculator 28 may be adapted to use adjoining pixel data grouped by color to calculate a correction value color by color.

The seam corrector 30 is adapted for using the seam correction values 130 read out from the recorder 26 to correct the seam between divided images respectively represented by the digital image signals 124 and 126. For example, if the seam correction values 130 produced by the correction value calculator 28 are based on the formula (A−B)/B+1, then the seam corrector 30 multiplies the entire digital image signal 126 by the seam correction values 130 for thereby correcting the signal 126. In this manner, the seam corrector 30 matches the digital image signal 126 to the digital image signal 124, so that the resulting combined image is free from differences in level.

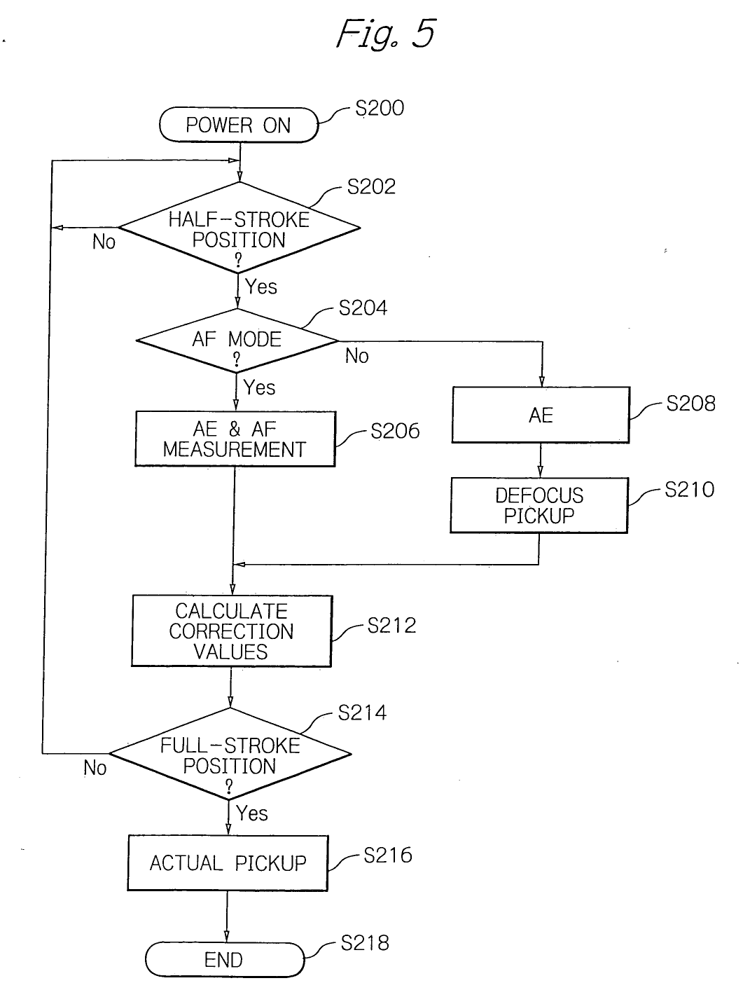

Reference will be made to FIG. 5 for describing a specific operation of the solid-state image pickup apparatus 10. As shown, when the apparatus 10 is powered on and in its initial state (step S200), the operator of the apparatus 10 depresses the shutter release button of the control panel 14. It is then determined whether or not the shutter release button is depressed to its half-stroke position (step S202). If the shutter release button is depressed to its half-stroke position or more (Yes, step S202), then the control panel 14 sends an operation signal 106 indicative of preliminary pickup to the system controller 16. This is followed by a step S204. On the other hand, if the shutter release button is in a position short of its half-stroke position (No, step S202), then the procedure returns to the initial stage.

In the step S204, the system controller 16 determines whether or not the operation signal 106 from the control panel 14 is indicative of the AF mode. The system controller 16 executes a step 206 if the answer of the step 204 is positive, Yes, or executes a step S208 if it is negative, No.

In the step S206, the system controller 16 generates control signals 108 and 110 indicative of AF and AE control, respectively, at the preliminary pickup stage and delivers the signals 108 and 110 to the timing generator 18 and signal processor 24, respectively.

In response to the control signal 108, the timing generator 18 delivers timing signals 114, 116 and 118 to the image pickup section 12, preprocessor 20 and AD converter 22, respectively.

The image pickup section 12 picks up the image of a subject field in response to the timing control signal 114 and produces analog electric signals 102 and 104 representative of the image of the field for the respective divided regions 152 and 154. The preprocessor 20 and AD converter 22 sequentially process the analog electric signals 102 and 104 to thereby output corresponding digital image signals 124 and 126. The digital image signals 124 and 126 are input to the signal processor 24.

The signal processor 24, having received the control signal 110 indicative of preliminary pickup, calculates estimated luminance and contracts values on the basis of the digital image signals 124 and 126 and delivers an adjustment signal 132 representative of such estimated values to the system controller 16. The system controller 16 determines an exposure and a focus condition in accordance with the estimated luminance and contrast values.

Further, the signal processor 24 detects first and second adjoining pixel data based on the adjoining pixels 156 and 158, respectively, out of the digital image signals 124 and 126 picked up at a defocus position. The first and second adjoining pixel data thus detected are conveyed to the system controller 16 by the adjustment signal 132. In this condition, a step S212 is executed.

On the other hand, in the step S208, the system controller 16 generates control signals 108 and 110 indicative of AE control at the preliminary pickup state and feeds the control signals 108 and 110 to the timing generator 18 and signal processor 24, respectively. In this case, because the MF mode is selected by the operator instead of the AF mode, the image pickup section 12 is manually focused at a focus position set by hand.

In the step S208, the timing generator 18 feeds timing control signals 114, 116 and 118 to the image pickup section 12, preprocessor 20 and AD converter 22, respectively, in response to the control signal 108 as in the step S106. Analog electric signals 102 and 104, generated by the image pickup signal 12, are again sequentially processed by the preprocessor 20 and AD converter 22. Subsequently, digital image signals 124 and 126, respectively derived from the analog electric signals 102 and 104, are input to the signal processor 24.

The signal processor 24, having received the control signal 110 indicative of preliminary pickup, calculates estimated luminance values in response to the digital image signals 124 and 126 input from the AD converter 22 and delivers the two kinds of estimated values to the system controller 16 as an adjustment signal 132.

In a step 210 following the step 208, while the system controller 16 determines an exposure condition in accordance with the estimated luminance values fed thereto, as stated earlier, it outputs control signals 108 and 110 indicative of pickup at a defocus position, as distinguished from the set focus position, in order to determine a focus condition. With the control signals 108 and 110, the system controller 16 eventually controls the image pickup section 12, preprocessor 20 and AD converter 22. Consequently, digital image signals 124 and 126 picked up at the defocus position are output from the AD converter 22 to the signal processor 24.

The signal processor 24 detects first and second adjoining pixel data based on the adjoining images 156 and 158 out of the input digital image signals 124 and 126, respectively. The first and second adjoining pixel data are conveyed to the system controller 16 by the adjustment signal 132. This is the end of the defocus pickup step S210.

In the step S212 following the step S206 or 210, the correction value calculator 28, included in the system controller 16, calculates seam correction values 112 on the basis of the first and second adjoining pixel data and writes the seam correction values in the recorder 26.

After the step S212, it is determined whether or not the shutter release button is depressed to its full-stroke position by the operator (step S214). If the shutter release button is depressed to its full-stroke position (Yes, step S214), an operation signal 106 indicative of actual pickup is fed from the control panel 14 to the system controller 16. In response, the system controller 16 causes the image pickup apparatus 10 to perform actual pickup, i.e. actually shoot the desired scene (step S216). If the answer of the step S214 is No, then the procedure returns to the initial stage.

More specifically, in the step S216, the system controller 16 generates control signals 108 and 110 indicative of actual pickup and delivers the control signals 108 and 110 to the timing generator 18 and signal processor 24, respectively. At this instant, the control signals 108 and 110 include the exposure and focus conditions determined at the preliminary pickup stage.

The timing generator 18 feeds timing control signals 114, 116 and 118 based on the control signal 108 to the image pickup section 12, preprocessor 20 and AD converter 22, respectively, as in the preliminary pickup step. Subsequently, analog electric signals 102 and 104, generated by the image pickup section 12 in response to the timing control signal 114, are sequentially processed by the preprocessor 20 and AD converter 22. As a result, digital image signals 124 and 126, respectively corresponding to the analog electric signals 102 and 104, are fed from the AD converter 22 to the signal processor 24.

The signal processor 24, when received the control signal 110 indicative of actual pickup, executes white balance control, gamma correction, image combination, synchronization and other digital signal processing on the digital image signals 124 and 126. At this instant, before the combination of the digital image signals 124 and 126, the seam corrector 30 corrects a seam with the seam correction values 130 read out from the recorder 26. For example, the seam corrector 30 multiples the entire digital image signal 126 by the seam correction values 130 for thereby matching the digital image signal 126 to the digital image signal 124.

A digital image signal 128 thus subjected to digital processing by the signal processor 24 is written to the recorder 26. While the illustrative embodiment is structured to end the operation of the image pickup apparatus 10 after the writing of the digital image signal 128 in the recorder 26 (step S218), the system may be adapted to display the digital image signal 128 on a monitor, not shown, prior to the end of the procedure, if desired.

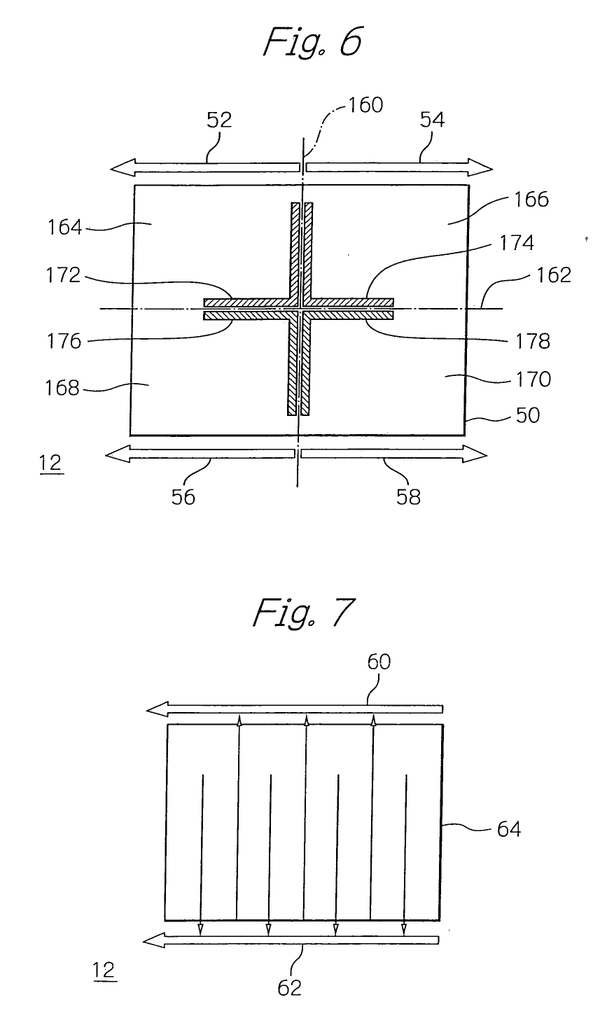

The image pickup section 12 may be provided with a plurality of horizontal transfer paths which are configured to transfer signal charges read out from the imaging surface separately to output a corresponding plural streams of analog electric signals. For example, in a specific modification shown in FIG. 6, the image pickup section 12 includes an array of photosensitive cells, or imaging surface, 50 constituting a single frame of image and four horizontal transfer paths 52, 54, 56 and 58. The imaging surface 50 is divided into an upper-left and an upper-right region 164 and 166, respectively, in the figure, by a seam 160 and a lower-left and a lower-right region 168 and 170, respectively, by a seam 162. The image pickup section 12 is equipped with four horizontal transfer paths 52, 54 and 56, 58, which are disposed above and below, in the figure, the imaging surface 50, as depicted. In this configuration, signal charges read out from the divided regions 164 through 170 are transferred over the horizontal transfer paths 52 through 58, respectively, and then converted to four analog electric signals.

The imaging surface 50 shown in FIG. 6 maybe implemented as the four physically divided regions 164 through 170, or configured as a physically single frame having a plurality of regions on its imaging surface. Pixels, adjoining each other at both sides of the seams 160 and 162 in the divided regions 164 through 170 of the imaging surface 50, are dealt with as adjoining pixels 172, 174, 176 and 178, respectively.

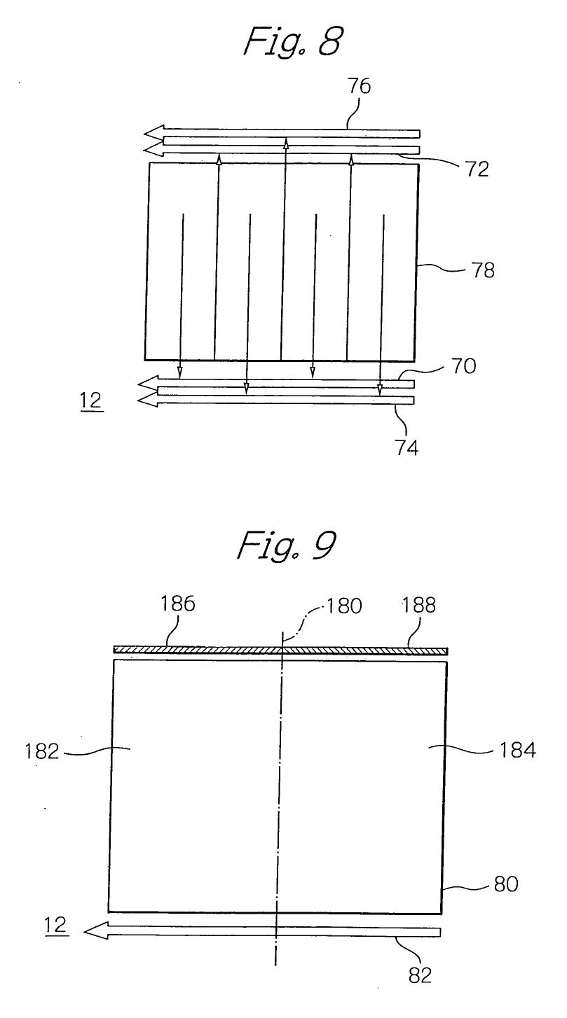

FIGS. 7 and 8 each show another particular configuration of the divisional reading type of image pickup section 12. In FIG. 7, signal charges read out from the imaging surface 64 are transferred to two horizontal transfer paths 60 and 62 alternately with each other. The horizontal transfer paths 60 and 62 are provided upward and downward, in the figure, of the imaging surface 64, respectively. In FIG. 8, signal charges are sequentially transferred to a plurality of, four, horizontal transfer paths 70, 74 and 72, 76, disposed downward and upward, in the figure, of the imaging surface 78, respectively.

When the image pickup section 12 is of the divisional readout type, a plurality of horizontal transfer paths are connected to a respective output amplifier, not shown, each. In this case, the correction value calculator 28 of the system controller 16 may be adapted to calculate, based on adjoining pixel data, a particular correction value for correcting the gain of each output amplifier in order to reduce differences between a plurality of adjoining pixel data.

In the modifications to the image pickup apparatus 10 described above, the preprocessor 20 is adapted to receive a plural streams of analog electric signals, and, for that aim, to include a corresponding plurality of gain-controlled amplifiers, not shown, assigned one-to-one to the analog electric signal streams. In this case, the correction value calculator 28, included in the system controller 16, may be adapted to calculate, based on the adjoining pixel data, correction values each for correcting the gain of a particular gain-controlled amplifier in order to reduce differences between adjoining pixel data.

At the preliminary pickup stage, the image pickup apparatus 10 of the illustrative embodiment picks up a preselected subject with different exposure times, so that the signal processor 24 attains estimated luminance values and then calculates linearity representative of a relation between the exposure time and the estimated luminance value. In the illustrative embodiment, the signal processor 24 calculates a plurality of linearities for the plurality of divided regions. At this time, the signal processor 24 may be adapted for obtaining estimated luminance values from adjoining pixel data to calculate linearity.

The correction value calculator 28 may also be configured to calculate correction values to be used for the correction of the digital image signals input to the signal processor 24 and for the improvement on differences between the plurality of linearities mentioned above. For example, the correction value calculator 28 may calculate correction values to be used for the correction of offset of preselected linearity from the other reference linearity, and may use a mean value of the plurality of linearities as reference linearity.

An alternative embodiment of the present invention also practicable with the circuitry of FIG. 1 will be described hereinafter. Briefly, the alternative embodiment includes a plurality of optical black (OB) regions assigned to a respective divided region each, and uses differences between signals derived from the OB regions to calculate correction values for correcting a seam in an image between the divided regions.

As shown in FIG. 9 specifically, the image pickup section 12 includes an imaging surface 80 and a horizontal transfer path 82. The imaging surface 80 is divided into a right and a left region 184 and 182, respectively, by a seam 180. Particularly, in the alternative embodiment, the image pickup section 12, FIG. 1, includes OB regions 186 and 188 corresponding to the divided regions 182 and 184, respectively.

The image pickup section 12 may be configured to output OB image data obtained from the OB regions 186 and 188 at the same time as or independently of image signals derived from the regions 182 and 184, respectively. The OB image data are sequentially processed by the preprocessor 20, AD converter 22 and signal processor 24, FIG. 1, as in the previous embodiment.

Now, in the following, values produced by processing the OB image data obtained from the OB regions 186 and 188 and then averaging the results of processing will be represented by image data C and D, respectively. The correction values to be used by the seam corrector 30 of the signal processor 24, FIG. 1, may be calculated out as a difference between the image data C and D, i.e. (D−C). In this case where correction values are obtained from a difference in image data, the seam corrector 30, FIG. 1, executes correction by subtracting the correction value thus produced only from the digital image signal derived from the divided region 184.

The signal processor 24 may be adapted to feed the image data C and D mentioned above to the correction value calculator 28 of the system controller 16, FIG. 1, and cause the calculator 28 to calculate correction values at the seam. The resulting seam correction values 112, FIG. 1, are written to the recorder 26, FIG. 1, and then read out from the recorder 26 when the signal processor 24 executes signal processing at the actual pickup stage. The seam correction values, labeled 130, thus read out from the recorder 26 are used to correct digital image signals by the seam corrector 30.

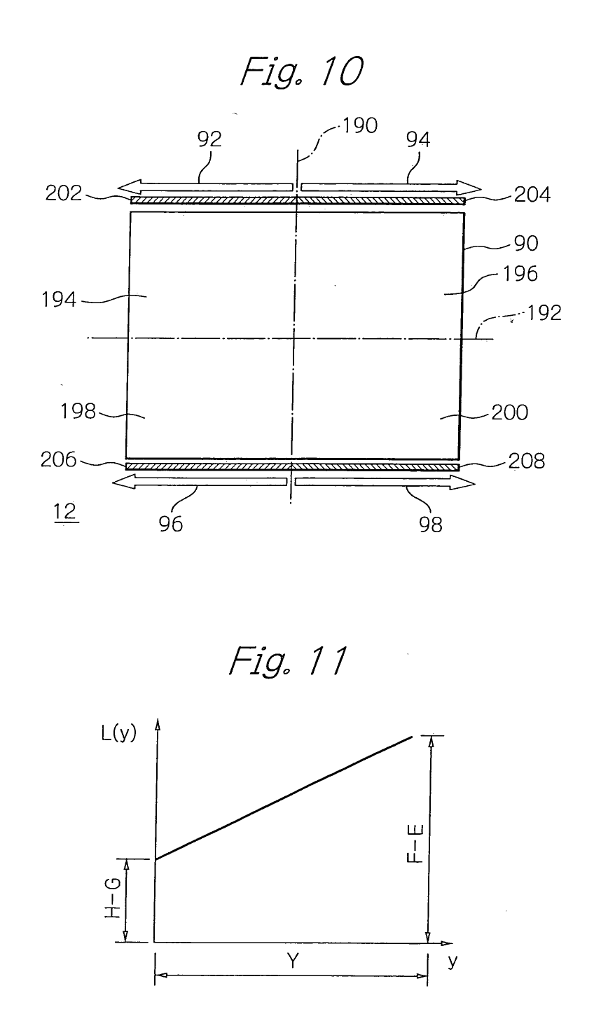

In the alternative embodiment, too, when color filter segments of, e.g. R, G and B are positioned in the OB regions 186 and 188 that derive the OB image data, the OB image data may be grouped by color so as to allow the correction value calculator 28 to calculate correction values color by color. 67) The image pickup section 12 may be configured such that signal charges are read out from the imaging surface in groups over a plurality of horizontal transfer paths and output as a corresponding plurality of analog electric signal streams. For example, FIG. 10 shows an alternative configuration of the image pickup apparatus 12 including an imaging surface 90, which constitutes one frame of imaging field, and a plurality of, four, horizontal transfer paths 92, 94, 96 and 98. The imaging surface 90 is divided into an upper-left and an upper-right region 194 and 196 and a lower-left and a lower-right region 198 and 200 by seams 190 and 192, respectively. The horizontal transfer paths 92, 94 and 96, 98 are arranged respectively along the upper and lower peripheries, in the figure, of the imaging surface 90 substantially in parallel to the latter, as illustrated. In that configuration, four streams of signal charges read out from the four regions 194, 196, 198 and 200 are transferred over the horizontal transfer paths 92, 94, 96 and 98, respectively, in the respective directions indicated with the respective arrows in the figure so that four different analog electric signal streams are generated. Particularly, in FIG. 10, the divided regions 194, 196, 198 and 200 include OB regions 202, 204, 206 and 208, respectively.

With the alternative embodiment thus configured, the correction value calculator 28 is adapted to calculate the seams correction values with a function having its gradient implemented as differences between the respective OB image data in the upper and lower and right and left divided regions. For example, in the case of the configuration shown in FIG. 10, the correction value calculator 28 processes OB image signals output from the four OB regions 202 through 208, and then produces image data E, F, G and H which are the mean values of the resulting processed OB image data. Assuming that the imaging surface 90, FIG. 10, has its height Y in the up-and-down direction in the figure, represented in pixels, for example, and that a given position in the up-and-down direction is represented by coordinates y, then a correction value L(y) for the coordinates y may be produced by [{(F−E)−(H−G)}/Y+(D−C)]*y. A relation between the correction value L (y) and the coordinates y is plotted in FIG. 11.

In the above condition, assuming that pixel data at the coordinates y are M(y), then the pixel data M(y) may be corrected to pixel data N(y) by M(y)−L(y).

In a further alternative embodiment of the present invention, the image pickup apparatus 10 is configured to determine whether or not the correction of a seam or seams between divided regions is necessary, and execute correction if necessary. For the correction of a seam or seams, there may be used either one of the adjoining data at a seam and OB image data.

In the alternative embodiment stated above, the signal processor 24, for example, may include a decision circuit, not shown, for determining whether or not correction is necessary. The decision circuit may be adapted to make such a decision in response to the control signal 110 output from the system controller 16 and indicative of preliminary pickup.

The decision circuit may be adapted to feed the result of the decision to the system controller 16, in which case the correction value calculator 28 of the system controller 16 calculates correction values for a seam if correction is necessary, and otherwise not. This is also true with the seam corrector 30 included in the signal processor 24. Specifically, the seam corrector 30 calculates correction values for a seam only when correction is necessary. For example, the decision circuit determines, based on the digital image signals 124 and 126 output at the preliminary pickup stage, whether frequency components are low throughout the entire image data, and then determines that correction is necessary if they are substantially low.

More specifically, when the image pickup apparatus 10 shoots a generally flat wall, sky or similar flat subject, luminance varies little over the entire optical image of the subject with the result that the frequency components of image signals output at the actual pickup stage are substantially low in the entire image. In such a condition, a seam or seams between divided images are particularly conspicuous in the resulting image, so that the decision circuit determines that correction is required at the seam or seams.

Alternatively, the decision circuit may produce an estimated AE value during AE control from the digital image signals 124 and 126 at the preliminary exposure stage, and determine whether or not correction is necessary on the basis of the estimated AE value. In this case, the estimated AE value may be implemented by one representative of the light and shade of the entire image picked up, e.g. an estimated AE value represented by the accumulated value of luminance signals based on the digital image signals 124 and 126. Assuming that the estimated AE value lies in, e.g. any one of a light, a dark and a medium range, when classified, the decision circuit may preferably be adapted for determining that correction is necessary if the estimated AE value lies in the medium range.

As shown in FIG. 4, in the AF control mode, a desired subject is automatically focused on the image pickup section 12 in order to detect an optimum focus position where the optical image of the subject is adequately obtained. However, when the image pickup apparatus 10 shoots a substantially entirely black subject, substantially the same estimated contrast value is produced without regard to the focus position. More specifically, it is likely that a peak included in the estimated contrast values shown in FIG. 4 with respect to the focus position does not appear at all but the estimated contrast value becomes simply flat, preventing an optimum focus position from being detected.

In the instant alternative embodiment, the decision circuit determines that correction is necessary if the estimated contrast values remain the same at any focus position.

Further, the image pickup apparatus 10 shown and described may be modified to operate in the same manner as in the preliminary pickup mode as soon as the apparatus 10 is turned on, shooting a field via the image pickup section 12. The resulting digital image signals 124 and 126 are input to the correction calculator 28 via the signal processor 24, causing the calculator 28 to calculate correction values for a seam. The correction values thus calculated at the time of power-up are written to the recorder 26 as initial information and read out at the time of actual pickup for allowing the seam corrector 30 to correct a seam.

The seam corrector 30 may be adapted to correct a seam with the correction values initially stored in the recorder 26 or correct, if the decision circuit determines that correction is necessary, a seam with correction values newly calculated by the correction value calculator 28.

In accordance with the present invention, correction values are calculated on the basis of image data input to the signal processor to be used for correcting a divided image. Therefore, the present invention is applicable even to an apparatus of the type involving an external sensor in exposure and focus control, or an image input apparatus merely adapted for receiving data of divided images.

In summary, in accordance with the present invention, a solid-state image pickup apparatus uses correction values produced from adjoining image data derived from adjoining pixels at a seam of a divided image, and can therefore correct level differences at the seam with a simple configuration without regard to temperature, optical conditions and other variable image capturing conditions, thereby insuring high image quality. This advantage is also achievable even when the correction values for the seam are produced from image data read out from OB regions.

The entire disclosure of Japanese patent application Nos. 2005-62636 and 2006-27091 filed on Mar. 7, 2005 and Feb. 3, 2006, respectively, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A solid-state image pickup apparatus comprising:
an image sensor including an imaging surface made up of a plurality of divided regions for producing a plurality of analog electric signal streams representative of a corresponding plurality of divided images on a basis of the plurality of divided regions;
an analog signal processor for executing analog signal processing on the plurality of analog electric signal streams and converting resulting processed analog electric signals to a corresponding plurality of digital image signals; and
a digital signal processor for executing digital signal processing on each of the plurality of digital image signals to thereby produce a single frame of image;
said apparatus being selectively operable at an actual pickup stage for producing an image by picking up a field, or at a preliminary pickup stage for obtaining an exposure condition and a focus condition,
said digital signal processor including a detector for detecting, at the preliminary pickup stage, out of the plurality of digital image signals a plurality of level decision data for determining level differences between the plurality of divided images;
said apparatus further comprising:
a correction value calculator for calculating, at the preliminary pickup stage, correction values for correcting the level differences between the plurality of divided images in accordance with the plurality of level decision data; and
a corrector for correcting, at the actual pickup stage, the plurality of divided images with the correction values calculated by said correction value calculator.

2. The apparatus in accordance with claim 1, wherein said detector detects, at the preliminary pickup stage, the plurality of level decision data out of the plurality of digital image signals focused and picked up at a defocus position.

3. The apparatus in accordance with claim 1, wherein assuming that pixels adjoining each other at both sides of a seam between the plurality of divided images are a plurality of adjoining pixels, said detector detects a plurality adjoining pixel data based on the plurality of adjoining pixels out of the corresponding plurality of digital image signals as the plurality of level decision data.

4. The apparatus in accordance with claim 3, wherein said correction value calculator calculates, based on the adjoining pixel data grouped by a color of a color filter segment assigned to each adjoining pixel, the correction values on a color filter segment basis.

5. The apparatus in accordance with claim 3, wherein the imaging surface is physically divided to form the plurality of divided regions,
said image sensor transferring signal charges read out from the plurality of regions to an output circuit over a horizontal transfer path, whereby a plurality of analog electric signals are generated.

6. The apparatus in accordance with claim 3, wherein the imaging surface is physically divided to form the plurality of divided regions,
said image sensor transferring signal charges read out from each of the plurality of divided regions to particular one of the plurality of horizontal transfer paths and then to particular one of a plurality of output circuits, whereby a plurality of analog electric signals are generated.

7. The apparatus in accordance with claim 3, wherein the imaging surface comprises physically a single frame,
said image sensor having the imaging surface divided into the plurality of divided regions, and transferring signal charges read out from each of the plurality of divided regions to particular one of the plurality of horizontal transfer paths and then to particular one of a plurality of output circuits, whereby a plurality of analog electric signals are generated.

8. The apparatus in accordance with claim 1, wherein said image sensor includes a plurality of optical black regions each corresponding to particular one of the plurality of divided regions,
said detector detecting a plurality of optical black image data based on said plurality of optical black regions out of the plurality of digital image signals as the plurality of level decision data.

9. The apparatus in accordance with claim 8, wherein said correction data calculator calculates, based on the optical black image data grouped by a color of a color filter segment and obtained from the plurality of optical black regions, the correction values on a color filter segment basis.

10. The apparatus in accordance with claim 8, wherein said imaging surface is physically divided into the plurality of divided regions,
said image sensor transferring signal charges read out from the plurality of divided regions and the plurality of optical black regions to a horizontal transfer path, and then to a plurality of output circuits, whereby a plurality of analog electric signals are generated.

11. The apparatus in accordance with claim 8, wherein said imaging surface is physically divided into the plurality of divided regions,
said image sensor transferring signal charges read out from each of the plurality of divided regions and each of the plurality of optical black regions to particular one of a plurality of horizontal transfer path, and then to particular one of a plurality of output circuits, whereby a plurality of analog electric signals are generated.

12. The apparatus in accordance with claim 8, wherein the imaging surface comprises physically a single frame,
said image sensor having the imaging surface divided into the plurality of divided regions, and transferring signal charges read out from each of the plurality of divided regions and each of the plurality of optical black regions to particular one of the plurality of horizontal transfer paths, and then to particular one of a plurality of output circuits, whereby a plurality of analog electric signals are generated.

13. The apparatus in accordance with claim 3, wherein said correction value calculator calculates the correction values that correct offsets of the plurality of digital signals in such a manner as to reduce differences between the plurality of level decision data,
said corrector correcting the plurality of digital image signals with the correction values.

14. The apparatus in accordance with claim 8, wherein said correction value calculator calculates the correction values that correct offsets of the plurality of digital signals in such a manner as to reduce differences between the plurality of level decision data,
said corrector correcting the plurality of digital image signals with the correction values.

15. The apparatus in accordance with claim 3, wherein said analog signal processor includes a plurality of analog amplifiers each for amplifying particular one of the plurality of analog electric signal streams,
said correction value calculator calculating the correction values that correct amplification gains of said plurality of amplifiers in such a manner as to reduce differences between the plurality of level decision data in accordance with the plurality of level decision data,
said corrector using the correction values to correct the amplification gains of said plurality of analog amplifiers.

16. The apparatus in accordance with claim 8, wherein said analog signal processor includes a plurality of analog amplifiers each for amplifying particular one of the plurality of analog electric signal streams,
said correction value calculator calculating the correction values that correct amplification gains of said plurality of amplifiers in such a manner as to reduce differences between the plurality of level decision data in accordance with the plurality of level decision data,
said corrector using the correction values to correct the amplification gains of said plurality of analog amplifiers.

17. The apparatus in accordance with claim 6, wherein each of said plurality of output circuits includes an output amplifier for amplifying corresponding one of the plurality of analog electric signals,
said correction value calculator calculating the correction values that correct amplification gains of the plurality of output amplifiers in such a manner as to reduce level differences between the plurality of level decision data in accordance with said plurality of level decision data,
said corrector correcting amplification gains of said plurality of output amplifiers with the correction values.

18. The apparatus in accordance with claim 7, wherein each of said plurality of output circuits includes an output amplifier for amplifying corresponding one of the plurality of analog electric signals,
said correction value calculator calculating the correction values that correct amplification gains of the plurality of output amplifiers in such a manner as to reduce level differences between the plurality of level decision data in accordance with said plurality of level decision data,
said corrector correcting amplification gains of said plurality of output amplifiers with the correction values.

19. The apparatus in accordance with claim 11, wherein each of said plurality of output circuits includes an output amplifier for amplifying corresponding one of the plurality of analog electric signals,
said correction value calculator calculating the correction values that correct amplification gains of the plurality of output amplifiers in such a manner as to reduce level differences between the plurality of level decision data in accordance with said plurality of level decision data,
said corrector correcting amplification gains of said plurality of output amplifiers with the correction values.

20. The apparatus in accordance with claim 12, wherein each of said plurality of output circuits includes an output amplifier for amplifying corresponding one of the plurality of analog electric signals,
said correction value calculator calculating the correction values that correct amplification gains of the plurality of output amplifiers in such a manner as to reduce level differences between the plurality of level decision data in accordance with said plurality of level decision data,
said corrector correcting amplification gains of said plurality of output amplifiers with the correction values.

21. The apparatus in accordance with claim 3, wherein said digital signal processor calculates, at the preliminary pickup stage, a linearity representative of a relation between a luminance value and an exposure time for each of the plurality of level decision data,
said correction value calculator calculating the correction values that correct the plurality of digital image signals in such a manner as to reduce differences between a plurality of linearities based on the plurality of level decision data,
said corrector correcting the plurality of digital image signals with the correction values.

22. The apparatus in accordance with claim 8, wherein said digital signal processor calculates, at the preliminary pickup stage, a linearity representative of a relation between a luminance value and an exposure time for each of the plurality of level decision data,
said correction value calculator calculating the correction values that correct the plurality of digital image signals in such a manner as to reduce differences between a plurality of linearities based on the plurality of level decision data,
said corrector correcting the plurality of digital image signals with the correction values.

23. The apparatus in accordance with claim 8, wherein said image sensor has the plurality of optical black regions positioned above and below or rightward and leftward of the imaging surface,
said correction value calculator calculating a function having a gradient of differences between the image data of an upper and a lower optical black regions or a right and a left optical black regions, and calculating, based on the function, the correction values that correct the plurality of digital image signals in such a manner as to reduce differences between the plurality of level decision data,
said corrector correcting the plurality of image signals with the correction values calculated by said correction value calculator.

24. The apparatus in accordance with claim 1, further comprising a decision circuit for determining whether or not a seam between the plurality of divided images should be corrected,
said correction value calculator calculating the correction values if said decision circuit determines that the seam should be corrected,
said corrector correcting the plurality of divided images with the correction values if said decision circuit determines that the seam should be corrected.

25. The apparatus in accordance with claim 24, wherein said decision circuit determines, based on the plurality of digital image signals, whether or not frequency components of the plurality of digital image signals are low throughout an image, said decision circuit determining that the seam should be corrected if the frequency components are low, or otherwise that the seam should not be corrected.

26. The apparatus in accordance with claim 24, wherein said decision circuit produces an estimation value in an automatic exposure control mode in response to the plurality of digital image signals, and determines whether or not the seam should be corrected on a basis of the estimation value.

27. The apparatus in accordance with claim 24, wherein said decision circuit produces an estimation value in an automatic focus control mode in response to the plurality of digital image signals, and determines whether or not the seam should be corrected on a basis of the estimation value.

28. The apparatus in accordance with claim 1, wherein said apparatus determines, when turned on, that correction values should be calculated and causes said correction value calculator to calculate the correction values.

29. An image input apparatus for inputting a plurality of divided image signals representative of a corresponding plurality of divided images, comprising:
a signal processor for processing the plurality of divided image signals to thereby produce a combined single image;
said signal processor comprising a detector for detecting a plurality of level decision data, which are used to determine level differences between the plurality of divided images, out of the plurality of divided image signals;
a correction value calculator for calculating correction values for correcting the level differences between the plurality of divided images in accordance with the plurality of level decision data; and
a corrector for using the correction values for correcting the plurality of divided images.

30. The apparatus in accordance with claim 29, wherein assuming that pixels adjoining each other at both sides of a seam between the plurality of divided images are a plurality of adjoining pixels, said detector detects a plurality adjoining pixel data based on the plurality of adjoining pixels out of the corresponding plurality of digital image signals as the plurality of level decision data.

31. The apparatus in accordance with claim 29, wherein said correction value calculator calculates the correction values that correct offsets of the plurality of divided image signals in such a manner as to reduce differences between the plurality of level decision data,
said corrector correcting the plurality of divided image signals with the correction values calculated by said correction value calculator.

32. A method of correcting an image, wherein, at an actual pickup stage, an image is produced by picking up a field, and, at a preliminary pickup stage, an exposure condition and a focus condition are obtained, said method comprising:
an image sensing step of producing a plurality of analog electric signal streams representative of a corresponding plurality of divided images on a basis of a plurality of divided regions, which constitute an imaging surface in combination;
an analog signal processing step of executing analog signal processing on the plurality of analog electric signal streams and converting resulting processed analog electric signals to a corresponding plurality of digital image signals; and
a digital signal processing step of executing digital signal processing on each of the plurality of digital image signals to thereby produce a single frame of image;
said digital signal processing step including a detecting substep of detecting, at the preliminary pickup stage, out of the plurality of digital image signals a plurality of level decision data for determining level differences between the plurality of divided images;
said method further comprising:
a correction value calculating step of calculating, at the preliminary pickup stage, correction values for correcting the level differences between the plurality of divided images in accordance with the plurality of level decision data; and
a correcting step of correcting, at the actual pickup stage, the plurality of divided images with the correction values calculated in said correction value calculating step.

33. The method in accordance with claim 32, wherein said detecting substep detects, at the preliminary pickup stage, the plurality of level decision data out of the plurality of digital image signals focused and picked up at a defocus position.

34. The method in accordance with claim 32, wherein assuming that pixels adjoining each other at both sides of a seam between the plurality of divided images are a plurality of adjoining pixels, said detecting substep detects a plurality adjoining pixel data based on said plurality of adjoining pixels out of the corresponding plurality of digital image signals as the plurality of level decision data.

35. The method in accordance with claim 34, wherein said correction value calculating step calculates, based on the adjoining pixel data grouped by a color of a color filter segment assigned to each adjoining pixel, the correction values on a color filter segment basis.

36. The method in accordance with claim 34, wherein the imaging surface is physically divided to form the plurality of divided regions, said imaging step transferring signal charges read out from the plurality of regions to an output circuit over a horizontal transfer path, whereby a plurality of analog electric signals are generated.

37. The method in accordance with claim 34, wherein the imaging surface is physically divided to form the plurality of divided regions, said image sensing step transferring signal charges read out from each of the plurality of divided regions to particular one of the plurality of horizontal transfer paths and then to particular one of a plurality of output circuits, whereby a plurality of analog electric signals are generated.

38. The method in accordance with claim 34, wherein the imaging surface comprises physically a single frame, said image sensing step dividing the imaging surface into the plurality of divided regions and transferring signal charges read out of each of the plurality of divided regions to particular one of the plurality of horizontal transfer paths and then to particular one of a plurality of output circuits, whereby a plurality of analog electric signals are generated.

39. The method in accordance with claim 32, wherein a plurality of optical black regions each are assigned to respective one of the plurality of divided regions, said detecting substep detecting a plurality of optical black image data based on the plurality of optical black regions out of the plurality of digital image signals as the plurality of level decision data.

40. The method in accordance with claim 39, wherein said correction data calculating step calculates, based on the optical black image data grouped by a color of a color filter segment and obtained from the plurality of optical black regions, the correction values on a color filter segment basis.

41. The method in accordance with claim 39, wherein the imaging surface is physically divided into the plurality of divided regions, said imaging step transferring signal charges read out from the plurality of divided regions and the plurality of optical black regions to a horizontal transfer path and then to a plurality of output circuits, whereby a plurality of analog electric signals are generated.

42. The method in accordance with claim 39, wherein the imaging surface is physically divided into the plurality of divided regions, said image sensing step transferring signal charges read out from each of the plurality of divided regions and each of the plurality of optical black regions to particular one of a plurality of horizontal transfer path and then to particular one of a plurality of output circuits, whereby a plurality of analog electric signals are generated.

43. The method in accordance with claim 39, wherein the imaging surface comprises physically a single frame, said image sensing step dividing the imaging surface into the plurality of divided regions and transferring signal charges read out from each of the plurality of divided regions and each of the plurality of optical black regions to particular one of the plurality of horizontal transfer paths and then to particular one of a plurality of output circuits, whereby a plurality of analog electric signals are generated.

44. The method in accordance with claim 34, wherein said correction value calculating step calculates the correction values that correct offsets of the plurality of digital signals in such a manner as to reduce differences between the plurality of level decision data, said correcting step correcting the plurality of digital image signals with the correction values.

45. The method in accordance with claim 39, wherein said correction value calculating step calculates the correction values that correct offsets of the plurality of digital signals in such a manner as to reduce differences between the plurality of level decision data, said correcting step correcting the plurality of digital image signals with the correction values.

46. The method in accordance with claim 34, wherein said analog signal processing step includes a plurality of analog amplifying substeps of amplifying respective ones of the plurality of analog electric signal streams,
said correction value calculating step calculating the correction values that correct amplification gains used in said plurality of analog amplifying substeps in such a manner as to reduce differences between the plurality of level decision data in accordance with the plurality of level decision data,
said correcting step using the correction values to correct the amplification gains of said plurality of analog amplifying steps.

47. The method in accordance with claim 39, wherein said analog signal processing step includes a plurality of analog amplifying substeps of amplifying respective ones of the plurality of analog electric signal streams,
said correction value calculating step calculating the correction values that correct amplification gains used in said plurality of analog amplifying substeps in such a manner as to reduce differences between the plurality of level decision data in accordance with the plurality of level decision data,
said correcting step using the correction values to correct the amplification gains of said plurality of analog amplifying steps.

48. The method in accordance with claim 37, further comprising a plurality of output amplifying steps of amplifying respective ones of the plurality of analog electric signals by corresponding one of the plurality of output circuits,
said correction value calculating step calculating the correction values that correct amplification gains in said plurality of output amplifying steps in such a manner as to reduce level differences between the plurality of level decision data in accordance with said plurality of level decision data,
said correcting step correcting amplification gains in said plurality of output amplifying steps with the correction values.

49. The method in accordance with claim 38, further comprising a plurality of output amplifying steps of amplifying respective ones of the plurality of analog electric signals by corresponding one of the plurality of output circuits,
said correction value calculating step calculating the correction values that correct amplification gains in said plurality of output amplifying steps in such a manner as to reduce level differences between the plurality of level decision data in accordance with said plurality of level decision data,
said correcting step correcting amplification gains in said plurality of output amplifying steps with the correction values.

50. The method in accordance with claim 42, further comprising a plurality of output amplifying steps of amplifying respective ones of the plurality of analog electric signals by corresponding one of the plurality of output circuits,
said correction value calculating step calculating the correction values that correct amplification gains in said plurality of output amplifying steps in such a manner as to reduce level differences between the plurality of level decision data in accordance with said plurality of level decision data,
said correcting step correcting amplification gains in said plurality of output amplifying steps with the correction values.

51. The method in accordance with claim 43, further comprising a plurality of output amplifying steps of amplifying respective ones of the plurality of analog electric signals by corresponding one of the plurality of output circuits,
said correction value calculating step calculating the correction values that correct amplification gains in said plurality of output amplifying steps in such a manner as to reduce level differences between the plurality of level decision data in accordance with said plurality of level decision data,
said correcting step correcting amplification gains in said plurality of output amplifying steps with the correction values.

52. The method in accordance with claim 34, wherein said digital signal processing step calculates, at the preliminary pickup stage, a linearity representative of a relation between a luminance value and an exposure time for each of the plurality of level decision data,
said correction value calculating step calculating the correction values that correct the plurality of digital image signals in such a manner as to reduce differences between a plurality of linearities based on the plurality of level decision data,
said correcting step correcting the plurality of digital image signals with the correction values.

53. The method in accordance with claim 39, wherein said digital signal processing step calculates, at the preliminary pickup stage, a linearity representative of a relation between a luminance value and an exposure time for each of the plurality of level decision data,
said correction value calculating step calculating the correction values that correct the plurality of digital image signals in such a manner as to reduce differences between a plurality of linearities based on the plurality of level decision data,
said correcting step correcting the plurality of digital image signals with the correction values.

54. The method in accordance with claim 39, wherein the plurality of optical black regions are positioned above and below or rightward and leftward of the imaging surface,
said correction value calculating step calculating a function having a gradient of differences between the image data of an upper and a lower optical black regions or a right and a left optical black regions, and calculating, based on the function, the correction values that correct the plurality of digital image signals in such a manner as to reduce differences between the plurality of level decision data,
said correcting step correcting the plurality of image signals with the correction values calculated in said correction value calculating step.

55. The method in accordance with claim 32, further comprising a deciding step of determining whether or not a seam between the plurality of divided images should be corrected,
said correction value calculating step calculating the correction values only if said deciding step determines that the seam should be corrected,
said correcting step correcting the plurality of divided images with the correction values only if said deciding step determines that the seam should be corrected.

56. The method in accordance with claim 55, wherein said deciding step determines, based on the plurality of digital image signals, whether or not frequency components of the plurality of digital image signals are low throughout an image, determines that the seam should be corrected if the frequency components are low or otherwise determines that the seam should not be corrected.

57. The method in accordance with claim 55, wherein said deciding step produces an estimation value in an automatic exposure control mode in response to the plurality of digital image signals and determines whether or not the seam should be corrected on a basis of the estimation value.

58. The method in accordance with claim 55, wherein said deciding step produces an estimation value in an automatic focus control mode in response to the plurality of digital image signals and determines whether or not the seam should be corrected on a basis of the estimation value.

59. The method in accordance with claim 32, wherein said method determines, at the time of power-up, that correction values should be calculated and causes said correction value calculating step to calculate the correction values.
